(19) United States
(12) Patent Application Publication
(10) Pub. No.: US 2025/0029991 A1
(43) Pub. Date: Jan. 23, 2025

(54) ANODE FOR LITHIUM SECONDARY BATTERY, AND LITHIUM SECONDARY BATTERY

(71) Applicants: SUMITOMO CHEMICAL COMPANY, LIMITED, Tokyo (JP); TOHOKU UNIVERSITY, Miyagi (JP)

(72) Inventors: Shingo MATSUMOTO, Tsukuba-shi (JP); Takitaro YAMAGUCHI, Tsukuba-shi (JP); Tetsu ICHITSUBO, Sendai-shi (JP); Hongyi LI, Sendai-shi (JP); Shohei NISHIMURA, Sendai-shi (JP)

(21) Appl. No.: 18/714,540

(22) PCT Filed: Dec. 2, 2022
(86) PCT No.: PCT/JP2022/044565

§ 371 Date: May 29, 2024

(30) Foreign Application Priority Data
Dec. 10, 2021 (JP) 2021-200898

(51) Int. Cl. H01M 4/46; H01M 4/02; H01M 4/04; H01M 4/134; H01M 4/66; H01M 4/75; H01M 10/052

(52) U.S. Cl. CPC H01M 4/463; H01M 4/0404; H01M 4/134; H01M 4/662; H01M 4/75; H01M 10/052; H01M 2004/027

(57) ABSTRACT

An anode for a lithium secondary battery, including: a cladding material obtained by bonding an anode active material layer and a current collector layer to each other, in which the anode active material layer contains aluminum, the current collector layer is made of a metal foil, and the anode active material layer satisfies (1) and (2) in which (1): an average voltage of a lithium alloying reaction in the anode active material layer measured using lithium metal as a counter electrode of the anode active material layer is 0.05 V or more, and (2): the average voltage of the lithium alloying reaction in the anode active material layer measured using lithium metal as the counter electrode of the anode active material layer is higher than an average voltage of a lithium alloying reaction in the current collector layer, and a difference in the average voltage of the lithium alloying reaction between the anode active material layer and the current collector layer is 0.05 V or more and 0.5 V or less.

### TECHNICAL FIELD

The present invention relates to an anode for a lithium secondary battery, and a lithium secondary battery.

Priority is claimed on Japanese Patent Application No. 2021-200898, filed Dec. 10, 2021, the content of which is incorporated herein by reference.

### BACKGROUND ART

In the related art, as for an anode included in a lithium secondary battery, studies are being conducted to improve battery performance using a material having a theoretical capacity higher than that of graphite, which is an anode material in the related art. As such a material, a metal material capable of occluding and releasing lithium ions like graphite has attracted attention.

For example, Patent Document 1 discloses a non-aqueous electrolytic solution battery using, as an anode, a laminated metal foil in which an aluminum metal layer is bonded to each of both surfaces of a metal base material layer that does not form an alloy with lithium.

### CITATION LIST

### Patent Document

[Patent Document 1]
Japanese Patent No. 6139776

### SUMMARY OF INVENTION

### Technical Problem

As application fields of the lithium secondary batteries expand, further improvement in cycle characteristics is required. A metal anode used in a lithium secondary battery has room for improvement in cycle characteristics.

The “cycle characteristics” are evaluated by a discharge capacity retention ratio when charging and discharging are repeated. A high discharge capacity retention ratio when a secondary battery is repeatedly charged and discharged is evaluated as “good cycle characteristics”.

The present invention has been made in view of the above circumstances, and an object of the present invention is to provide an anode for a lithium secondary battery capable of improving cycle characteristics of a lithium secondary battery, and a lithium secondary battery using the same.

### Solution to Problem

The present invention includes the following [1] to [6].

[1] An anode for a lithium secondary battery, including: a cladding material obtained by bonding an anode active material layer and a current collector layer to each other, in which the anode active material layer contains aluminum, the current collector layer is made of a metal foil, and the anode active material layer satisfies (1) and (2) in which
(1): an average voltage of a lithium alloying reaction in the anode active material layer measured using lithium metal as a counter electrode of the anode active material layer is 0.05 V or more, and
(2): the average voltage of the lithium alloying reaction in the anode active material layer measured using lithium metal as the counter electrode of the anode active material layer is higher than an average voltage of a lithium alloying reaction in the current collector layer, and a difference in the average voltage of the lithium alloying reaction between the anode active material layer and the current collector layer is 0.05 V or more and 0.5 V or less.

[2] The anode for a lithium secondary battery according to [1], in which the current collector layer is an aluminum alloy having a lower content ratio of Al than the anode active material layer.

[3] The anode for a lithium secondary battery according to [1] or [2], in which the current collector layer contains an element M2 which is one or more elements selected from the group consisting of Si, Fe, Ni, Cu, Mn, and Mg, and a content ratio of the element M2 to a total amount of the current collector layer is 0.1 mass % or more.

[4] The anode for a lithium secondary battery according to any one of [1] to [3], in which the anode active material layer contains aluminum, and a content ratio of an inevitable impurity contained in the aluminum is less than 0.1 mass %.

[5] The anode for a lithium secondary battery according to any one of [1] to [4], in which the anode active material layer contains an element M1 which is one or more elements selected from the group consisting of Si. Ge, Sn. Ag, Sb, Bi, In, Mn, and Mg, and a content ratio of the element M1 to a total amount of the anode active material layer is 0.1 mass % or more and 8 mass % or less.

[6] A lithium secondary battery including: the anode for a lithium secondary battery according to any one of [1] to [5].

### Advantageous Effects of Invention

According to the present invention, it is possible to provide an anode for a lithium secondary battery capable of improving cycle characteristics of a lithium secondary battery, and a lithium secondary battery using the same.

### BRIEF DESCRIPTION OF DRAWINGS

FIG. 1 is a schematic cross-sectional view showing an example of an anode for a lithium secondary battery of the present embodiment.

FIG. 2 is a schematic cross-sectional view showing an example of the anode for a lithium secondary battery of the present embodiment.

FIG. 3 is an example of a charging curve of the anode for a lithium secondary battery of the present embodiment.

FIG. 4 is an example of a charging curve of the anode for a lithium secondary battery of the present embodiment.

FIG. 5 is a schematic view of a lithium secondary battery of the present embodiment.

### DESCRIPTION OF EMBODIMENTS

### <Lithium Secondary Battery>

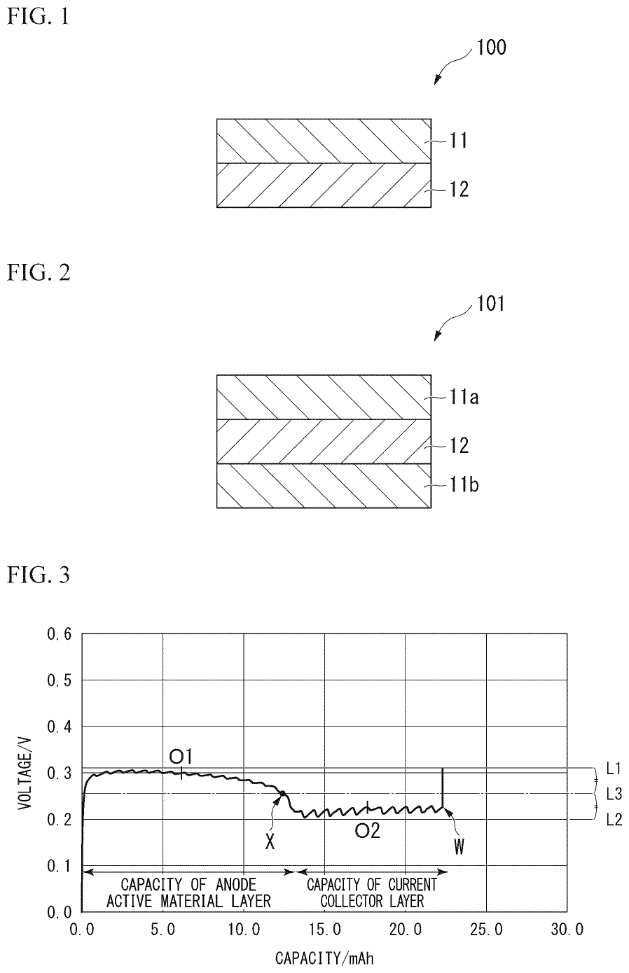

Hereinafter, an anode for a lithium secondary battery according to a first embodiment of the present invention will be described with reference to FIG. 1. In all the drawings below, the dimensions and ratios of each constituent element are appropriately different in order to make the drawings easier to see. Hereinafter, the anode for a lithium secondary battery according to the present invention may be abbreviated as “anode”.

### First Embodiment

FIG. 1 is a schematic cross-sectional view showing an example of an anode according to the present embodiment. An anode 100 shown in FIG. 1 is made of a cladding material in which an anode active material layer 11 and a current collector layer 12 are in direct contact with each other. The cladding material is a material obtained by bonding two or more kinds of different metals to each other.

In the anode 100, the anode active material layer 11 and the current collector layer 12 may be directly bonded to each other in a plane-to-plane manner, and for example, the current collector layer 12 may be exposed on both end surfaces of the anode 100. Here, “plane-to-plane” means faces of the anode active material layer 11 and the current collector layer 12 overlapping with each other when viewed in a plan view from a normal direction of an anode surface of the anode 100.

In a lithium secondary battery having an anode, in a case where a cathode is opposed to one surface, one surface of the anode functions as an anode active material. At this time, one surface corresponds to an “anode surface” in the present invention. The other surface of the anode is a surface of a current collector layer that functions as a current collector.

The anode active material layer 11 functions as an anode active material. The current collector layer 12 functions as a current collector. The anode 100 of the present invention is a current collector-integrated anode that serves both as the anode active material and as the current collector. Therefore, the anode 100 does not require a separate current collector.

When the present inventors aimed to improve cycle characteristics of a lithium secondary battery and were in the process of improving current collector-integrated anode, the present inventors encountered an issue where a current collector layer was eroded and penetrated when the lithium secondary battery was repeatedly charged and discharged.

In this case, when charging and discharging are repeated, a current collecting ability of the current collector layer decreases, and the current collector-integrated anode cannot be maintained. As a result, the cycle characteristics decrease.

The present inventors focused on a difference in potential when the anode active material layer 11 and the current collector layer 12 each alloyed with Li, and found that, when the anode active material layer 11 satisfies the following (1) and (2), the cycle characteristics are less likely to decrease, thereby completing the present invention.

A lithium alloying reaction means a reaction in which Li is alloyed with a material constituting the anode on the anode in a charging process.

The anode active material layer 11 satisfies the following (1) and (2).

(1): An average voltage of the lithium alloying reaction in the anode active material layer 11 measured using lithium metal as a counter electrode of the anode active material layer 11 is 0.05 V or more.

(2): The average voltage of the lithium alloying reaction in the anode active material layer 11 measured using lithium metal as the counter electrode of the anode active material layer 11 is higher than that of the current collector layer 12, and a difference in the average voltage of the lithium alloying reaction between the anode active material layer 11 and the current collector layer 12 is 0.05 V or more and 0.5 V or less.

Hereinafter, (1) and (2) will be described in order.

(1)

A method of measuring the average voltage of the lithium alloying reaction according to the configuration of (1) will be described below.

### [Method for Measuring Average Voltage of Lithium Alloying Reaction]

### (Manufacturing of Lithium Secondary Battery 1)

First, as a measurement target, a cladding material of the anode active material 11 having a thickness of 30 μm and the current collector layer 12 having a thickness of 120 μm is prepared. The cladding material is cut out into a disk shape having a diameter of φ15 mm to be used as the anode 100.

Next, a lithium foil is cut into a disk shape having a diameter of φ14.5 mm to manufacture the counter electrode.

Next, in a mixed solvent prepared by mixing ethylene carbonate (EC) and diethyl carbonate (DEC) at EC:DEC=30:70 (volume ratio), LiPF₆ is dissolved to 1.0 mol/L to manufacture an electrolytic solution.

A polyethylene porous separator is disposed between the anode active material layer 11 of the anode 100 and the counter electrode and accommodated in a battery case (standard 2032). The electrolytic solution is injected into the battery case, and the battery case is sealed, whereby a coin type (half-cell) lithium secondary battery 1 having a diameter of 20 mm and a thickness of 3.2 mm is manufactured.

### (Acquisition of Charging Curve)

The separator is sufficiently impregnated with the electrolytic solution by allowing the coin type lithium secondary battery 1 to be left at room temperature for 10 hours.

Next, constant current-constant voltage charging in which constant current charging (occlusion of Li in Al) to 0.05 V at 0.5 mA is performed at room temperature and constant voltage charging at 0.05 V is then performed is performed for 48 hours.

FIG. 3 shows an example of a charging curve obtained at this time.

When the anode 100, which is the cladding material, is measured under the above conditions, first, a charging curve of the anode active material layer 11 appears, and then a charging curve of the current collector layer 12 appears. Therefore, the charging curve of the anode 100 is a curve having two plateaus corresponding to the charging curve of the anode active material layer 11 and the charging curve of the current collector layer 12. Since there is a potential difference between the plateau of the charging curve of the anode active material layer 11 and the plateau of the charging curve of the current collector layer 12, in the charging curve of the anode 100, after a constant voltage is maintained from the start of the charging, the voltage sharply decreases when the lithium alloying reaction of the anode active material layer is substantially terminated.

From the appeared charging curve, an average voltage V1 of the lithium alloying reaction of the anode active material layer 11 and an average voltage V2 of the lithium alloying reaction of the current collector layer 12 are each calculated.

In the anode having the above-described configuration, a method of calculating V1 and V2 from the charging curve will be described with reference to FIG. 3 as an example.

First, the charging curve obtained when the anode 100, which is the cladding material, is measured under the above-described conditions is sandwiched between two parallel lines. In FIG. 3, the two parallel lines are denoted by L1 and L2, respectively. L1 is a line that has a maximum voltage of the plateau corresponding to the anode active material layer 11 in the charging curve as a y-coordinate and is parallel to an x-axis. L2 is a line that has a minimum voltage of the plateau corresponding to the current collector layer 12 in the charging curve as a y-coordinate and is parallel to the x-axis.

Next, a line L3 that has a value that equally divides a distance between the two parallel lines L1 and L2 as a y-coordinate and is parallel to the x-axis is determined. Coordinates of an intersection of L3 and the charging curve are denoted by X(a,b).

It is known that an average voltage during charging substantially matches a value with respect to a median value of a capacity when a charging curve is measured. Therefore, in the present specification, a voltage of an intersection O1 between x=a/2 and the charging curve is set as the average voltage V1 of the anode active material layer 11.

Similarly, in FIG. 3, when coordinates at which the charging is stopped are denoted by W(c,d), a voltage of an intersection O2 between the x=(c−a)/2 and the charging curve is set as the average voltage V2 of the current collector layer 12.

It should be noted that, although there is a slight potential difference in the vicinity of the median value on the charging curve, the potential difference in the vicinity of the median value is within a range of a small difference in a case of determining V1 and V2. In addition, a difference in capacity in the vicinity of the coordinate X is within a range of a small difference in a case of determining V1 and V2.

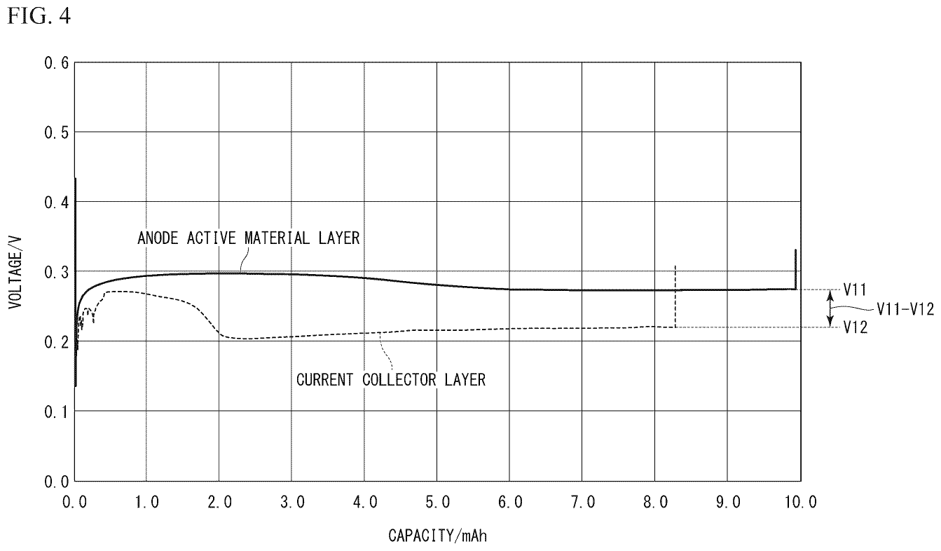

For reference, FIG. 4 shows an example of a charging curve obtained for each of the anode active material layer 11 and the current collector layer 11 by the same method as described above without cladding the anode active material layer 11 and the current collector layer 12.

In this case, an average voltage V1 calculated from the charging curve of the anode active material layer 11 and V12 calculated from the charging curve of the current collector layer 12 are obtained.

V11 corresponds to V1 above, and V12 corresponds to V2 above.

Although the description in the above example is provided based on the process of manufacturing the anode 100, in a case of measuring the average voltage of the lithium alloying reaction, for example, for an anode of a used lithium secondary battery that has already been charged and discharged, the anode may be taken out from the lithium secondary battery, and the average voltage may be measured for each of an unreacted anode active material layer and a current collector layer.

In addition, for example, in a case of measuring the average voltage of the lithium alloying reaction for an anode that is in circulation, a cross section of the anode is first observed by scanning electron microscopy-energy dispersive X-ray spectroscopy (SEM-EDX) to confirm that the anode is a cladding material.

Next, an anode surface of the anode active material layer is checked, and the above-described average voltage may be measured for the anode surface.

In the present embodiment, V1 is 0.05 V or more, preferably 0.1 V or more, and more preferably 0.2 V or more.

Examples of an upper limit of V1 include 1.0 or less, 0.8 V or less, and 0.5 V or less.

The upper limit and a lower limit of V1 can be randomly combined depending on a composition of the anode active material layer.

Examples of the combination include V1 of 0.05 V or more and 1.0 V or less, 0.05 V or more and 0.8 V or less, and 0.05 V or more and 0.5 V or less.

In the anode 100 in which V1 satisfies the above range, the anode active material layer 11 is easily alloyed with lithium and the current collector layer is not easily alloyed with lithium. Therefore, the anode 100 becomes an anode having excellent cycle characteristics.

(2)

(2) indicates that V1 is higher than V2 and a difference therebetween (V1−V2) is 0.05 V or more and 0.5 V or less. V1−V2 is preferably 0.05 V or more and 0.4 V or less, and more preferably 0.05 V or more and 0.3 V or less.

In the anode 100 in which V1 is higher than V2 and the difference therebetween satisfies the above range, lithium is likely to infiltrate into the anode active material layer 11 in a charged state. On the other hand, lithium is less likely to infiltrate into the current collector layer 12, and a metal composition before charging is more likely to be maintained after charging or after discharging. Therefore, even when charging and discharging are repeated, the current collecting ability of the current collector layer is less likely to decrease, and the cycle characteristics are less likely to decrease.

Hereinafter, materials of the anode active material layer 11 and the current collector layer 12 will be described.

### (Anode Active Material Layer 11)

The anode active material layer 11 contains aluminum

The anode active material layer 11 is made of, for example, aluminum.

The anode active material layer 11 is, for example, an aluminum alloy 1.

### Aluminum

In the present specification, aluminum refers to aluminum having a purity of Al of 99 mass % or more. Regarding the aluminum, the purity of Al is preferably 99.8 mass % or more, more preferably 99.9 mass % or more, still more preferably 99.95 mass % or more, and even more preferably 99.99 mass % or more.

In the present specification, the purity of Al means the purity of Al excluding an additive element for alloying.

The composition of the anode active material layer 11 can be confirmed by an inductively coupled plasma (ICP) analysis method. For example, the composition of the anode active material layer 11 can be measured using an ICP optical emission spectrometer (manufactured by SII NanoTechnology Inc., SPS3000).

Examples of a refining method for highly purifying aluminum to the above-described purity include a segregation method and a three-layer electrolysis method.

### (Segregation Method)

The segregation method is a purification method utilizing the segregation phenomenon during solidification of molten aluminum, and a plurality of methods have been put into practical use. As one form of the segregation method, there is a method of pouring molten aluminum into a container, and allowing refined aluminum to solidify from a bottom portion while heating and stirring the molten aluminum at an upper portion while rotating the container. By the segregation method, aluminum having a purity of 99.99 mass % or more can be obtained.

### (Three-Layer Electrolysis Method)

As one form of the three-layer electrolysis method, there is a method in which first, an aluminum ground metal having a minimum aluminum content of 99 mass % or more is fed into an aluminum-copper alloy layer. Thereafter, in the method, with an anode in a molten state, an electrolytic bath containing, for example, aluminum fluoride and barium fluoride is disposed thereon, and high-purity aluminum is precipitated on a cathode. By the three-layer electrolysis method, aluminum having a purity of 99.999 mass % or more can be obtained.

The refining method for highly purifying aluminum is not limited to the segregation method and the three-layer electrolysis method, and other known methods such as a zone melting and refining method and an ultra-high vacuum melting method may be used.

The material of the anode active material layer 11 is, for example, an aluminum alloy 1 containing Al and an element M1. The element M1 is one or more elements selected from the group consisting of Si, Ge, Sn, Ag, Sb, Bi, In, Mn, and Mg.

In the aluminum alloy 1, for example, a non-aluminum phase containing the element M1 is dispersed in an aluminum phase. The element contained in the non-aluminum phase is, for example, Si.

A content ratio of the element M1 to a total amount of the anode active material layer 11 is preferably 0.1 mass % or more and 8 mass % or less, more preferably 0.2 mass % or more and 7.9 mass % or less, and still more preferably 0.5 mass % or more and 7.8 mass % or less.

In a case where a ratio of a mass of the element M1 is equal to or more than the above-described lower limit, crystal grains of Al are refined, and cycle characteristics of the lithium secondary battery can be improved. In a case where the ratio of the mass of the element M1 is equal to or less than the above-described upper limit, precipitation of the element M1 during the charging and discharging of the lithium secondary battery can be suppressed.

A content ratio of inevitable impurities contained in the aluminum constituting the anode active material layer 11 is preferably less than 0.1 mass %, more preferably 0.05 mass % or less, and still more preferably 0.01 mass % or less.

The anode active material layer 11 inevitably contains a small amount of metal impurities (inevitable impurities). Examples of such inevitable impurities include production residues that are inevitably mixed in a refining step. Specific examples thereof include Fe, Cu, and Si.

The inevitable impurities do not contain an element that is intentionally added. However, an element common to the intentionally added element may be contained as an inevitable impurity. The intentionally added element is specifically the above-described element M1.

For example, the anode active material layer 11 may contain Si as the element M1 to be intentionally added. In this case, Si may be contained as an inevitable impurity.

Examples of the inevitable impurities contained in the aluminum constituting the anode active material layer 11 include Fe and Cu. A total content of Fe and Cu is preferably 300 ppm or less.

The aluminum alloy 1 as the material of the anode active material layer 11 is preferably an aluminum alloy 1 obtained by intentionally adding an element to aluminum having a purity as high as 99.99 mass % or more. Whether or not the aluminum alloy 1 is such an aluminum alloy 1 can be confirmed, for example, by using an ICP emission spectrometer. For the aluminum alloy 1 obtained by intentionally adding a small amount (for example, about 0.1 mass %) of an element to high-purity (for example, a purity of Al of 99.99 mass % or more) aluminum, a peak corresponding to the intentionally added element appears to a separable degree in addition to the Al peak. In this case, the aluminum alloy 1 can be determined as an aluminum alloy 1 obtained by intentionally adding an element to high-purity aluminum.

On the other hand, in a case where a plurality of peaks having no intensity bias other than the Al peak appear in the analysis of the anode active material layer 11 using the ICP emission spectrometer, the aluminum alloy 1 can be determined as low-purity aluminum containing inevitable impurities.

### (Current Collector Layer 12)

A material of the current collector layer 12 is a metal foil containing a metal that can be alloyed with Li. Examples of such a metal include aluminum, silicon, and magnesium.

The current collector layer 12 may be, for example, an aluminum foil, a silicon foil, or a magnesium foil.

From the viewpoint of easy cladding with the anode active material layer 11, the current collector layer 12 is preferably an aluminum alloy foil. In this case, as the current collector layer 12, an alloy is prepared to have a composition having a potential that is less likely to be alloyed with Li than the anode active material layer 11.

Li is less likely to intrude into the current collector layer 12 formed of the above material than into the anode active material layer 11. Accordingly, in a case where charging and discharging are repeated, the current collector layer 12 is likely to maintain the metal composition before charging.

The material of the current collector layer 12 is, for example, an aluminum alloy 2 containing Al and an element M2. The element M2 is one or more elements selected from the group consisting of Si, Fe, Ni, Cu, Mn, and Mg.

In the aluminum alloy 2, for example, a non-aluminum phase containing the element M2 is dispersed in an aluminum phase. The element contained in the non-aluminum phase is, for example, Si. The element M2 is an element that is intentionally added.

Examples of the material of the current collector include an aluminum-manganese alloy, an aluminum-silicon alloy, an aluminum-manganese-silicon alloy, an aluminum-magnesium alloy, and an aluminum-magnesium-silicon alloy.

A proportion of the element M2 contained in the current collector layer 12 is preferably 0.1 mass % or more, more preferably 0.5 mass % or more, and still more preferably 1 mass % or more. In addition, the proportion of the element M2 in the current collector layer 12 is, for example, 8 mass % or less, 6 mass % or less, and 5 mass % or less.

The above-described upper limit and lower limit of the proportion of the element M2 contained in the current collector layer 12 can be combined randomly. Examples of the combination include 0.1 mass % or more and 8 mass % or less, 0.5 mass % or more and 6 mass % or less, and 1 mass % or more and 5 mass % or less.

In a case where the element M2 is within the above range, a content ratio of Al in the current collector layer 12 is lower than that in the anode active material layer 11. In this case, the current collector layer 12 is less likely to be alloyed with lithium than the anode active material layer 11, and the current collector layer 12 is likely to maintain the composition before charging when charging and discharging are repeated.

Since a thickness of each of the anode active material layer 11 and the current collector layer 12 does not affect the cycle characteristics, the thickness can be appropriately designed and changed in order to maintain or improve strength.

From the viewpoint of reducing a weight of the anode 100, the thickness of the anode active material layer 11 is, for example, preferably 3 μm or more and 500 μm or less, and the thickness of the current collector layer 12 is preferably 1 μm or more and 300 μm or less.

As an example of the anode 100, the anode active material layer 11 is aluminum and the current collector layer 12 is the aluminum alloy 2.

As an example of the anode 100, the anode active material layer 11 is aluminum having a purity of 99.99 mass % or more, and the current collector layer 12 is an aluminum-manganese alloy.

As an example of the anode 100, the anode active material layer 11 is aluminum having a purity of 99.99 mass % or more, and the current collector layer 12 is an aluminum-manganese-silicon alloy.

As an example of the anode 100, the anode active material layer 11 is made of aluminum having a purity of 99.99 mass % or more, and the current collector layer 12 is an aluminum-magnesium alloy.

As an example of the anode 100, the anode active material layer 11 is aluminum having a purity of 99.99 mass % or more, and the current collector layer 12 is an aluminum-magnesium-silicon alloy.

As an example of the anode 100, the anode active material layer 11 is aluminum having a purity of 99.99 mass % or more, and the current collector layer 12 is an aluminum-silicon alloy.

As an example of the anode 100, the anode active material layer 11 is the aluminum alloy 1 and the current collector layer 12 is the aluminum alloy 2.

As an example of the anode 100, the anode active material layer 11 is an aluminum-silicon alloy, and the current collector layer 12 is an aluminum-manganese alloy. The aluminum-silicon alloy is an alloy of aluminum having a purity of 99.99 mass % or more and silicon, and a content ratio of Si contained in a total amount of Al and Si is 0.1 mass % or more and 8 mass % or less.

As an example of the anode 100, the anode active material layer 11 is an aluminum-silicon alloy, and the current collector layer 12 is an aluminum-manganese-silicon alloy.

As an example of the anode 100, the anode active material layer 11 is an aluminum-silicon alloy, and the current collector layer 12 is an aluminum-magnesium alloy.

As an example of the anode 100, the anode active material layer 11 is an aluminum-silicon alloy, and the current collector layer 12 is an aluminum-magnesium-silicon alloy.

As an example of the anode 100, the anode active material layer 11 is the aluminum 1-silicon alloy 1, and the current collector layer 12 is an aluminum-silicon alloy having a lower purity of Al than the aluminum-silicon alloy 1.

### Second Embodiment

FIG. 2 shows another aspect of the anode of the present embodiment. An anode 101 shown in FIG. 2 is made of a cladding material in which an anode active material layer 11a and an anode active material layer 11b forming a pair are directly laminated on both surfaces of the current collector layer 12.

Materials of the anode active material layer 11b and the anode active material layer 11a may be the same as or different from each other. From the viewpoint of easy manufacturing, it is preferable that the materials of the anode active material layer 11b and the anode active material layer 11a are the same.

Here, “the material of the anode active material layer 11b and the material of the anode active material layer 11a are the same” means that the materials have the same constituent metal element.

For example, in a case where aluminum X is used as the anode active material layer 11a, the anode active material layer 11b preferably uses aluminum Y. Purities of the aluminum X and the aluminum Y may be the same as or different from each other.

Thicknesses of the anode active material layer 11b and the anode active material layer 11a may be the same as or different from each other. From the viewpoint of easy manufacturing, it is preferable that the thicknesses of the anode active material layer 11b and the anode active material layer 11a are the same.

In the anode 101, only one of the anode active material layer 11a and the anode active material layer 11b may satisfy (1) and (2) above, or both the anode active material layer 11a and the anode active material layer 11b may satisfy (1) and (2) above.

### [Method of Measuring Cycle Retention Ratio]

For the anode for a lithium secondary battery, the cycle retention ratio is measured by the following method.

In order to measure a cycle retention ratio of the lithium secondary battery, a lithium secondary battery 2 for a cycle test is manufactured, and the cycle retention ratio is measured.

### (Manufacturing of Lithium Secondary Battery 2)

A coin type (full cell) lithium secondary battery including an anode made of aluminum and a cathode made of LiCoO₂ and having a diameter of 20 mm and a thickness of 3.2 mm is manufactured using the same method as described above for the lithium secondary battery 1, except that the lithium foil is replaced by the cathode made of LiCoO₂.

### (Cycle Test)

The separator and the cathode are sufficiently impregnated with the electrolytic solution by allowing the coin type lithium secondary battery to be left at room temperature for 10 hours.

Next, at room temperature, constant current-constant voltage charging in which constant current charging (occlusion of Li in Al) to 4.2 V at 1.0 mA is performed and constant voltage charging at 4.2 V is then performed is performed for a total of 6 hours. As discharging, constant current discharging to 3.4 V at 1.0 mA is performed. Charging and discharging are set as one time, and a cycle test is conducted by repeating charging and discharging.

### (Determination Criteria 1)

A discharge capacity (mAh) at a 5th cycle and a discharge capacity (mAh) at a 20th cycle are measured, and the cycle retention ratio is calculated by Expression 1 as follows.

Cycle retention ratio (%)=discharge capacity (mAh) at the 20th cycle/discharge capacity (mAh) at the 5th cycle×100 Expression 1

A cycle retention ratio of 80% or higher, obtained by Expression 1 above, is evaluated as a high cycle retention ratio.

### (Determination Criteria 2)

A discharge capacity (mAh) at a 5th cycle and a discharge capacity (mAh) at a 40th cycle are measured, and the cycle retention ratio is calculated by Expression 2 as follows.

Cycle retention ratio (%)=discharge capacity (mAh) at the 40th cycle/discharge capacity (mAh) at the 5th cycle×100 Expression 2

A cycle retention ratio of 80% or higher, obtained by Expression 2 above, is evaluated as a high cycle retention ratio.

### <Manufacturing Method 1 of Anode for Lithium Secondary Battery>

A method of manufacturing the anode of the present embodiment will be described.

The method of manufacturing the anode includes a step of preparing each of the material of the anode active material layer and the material of the current collector layer and a step of cladding the material of the anode active material layer and the material of the current collector layer.

### [Step of Preparing Material of Anode Active Material Layer]

In a case where aluminum is used as the material of the anode active material layer, aluminum is highly purified by the above-described segregation method or the three-layer electrolysis method.

The obtained ingot of the aluminum can be directly cut and used as the material of the anode active material. The ingot may be processed into a plate material by rolling, extrusion, forging, or the like.

In a case where the aluminum alloy 1 is used as the material of the anode active material layer, the element M1 is added to molten aluminum or molten aluminum and melted at 680° C. or higher and 800° C. or lower to obtain a molten alloy of Al and the element M1.

The molten alloy is preferably subjected to a treatment of removing gas and non-metallic inclusions for cleaning (for example, a vacuum treatment of molten aluminum). The vacuum treatment is performed, for example, under conditions of 700° C. or higher and 800° C.′ or lower, 1 hour or longer and 10 hours or shorter, and a degree of vacuum of 0.1 Pa or more and 100 Pa or less.

As the treatment for cleaning the molten alloy, a treatment using a flux, or a treatment of blowing an inert gas or chlorine gas can also be used.

The obtained molten alloy is usually cast in a casting mold to obtain an ingot. As the casting mold, an iron or graphite casting mold heated to 50° C. or higher and 200° C. or lower is used.

A material of the anode active material can be cast by a method of pouring a molten alloy at 680° C. or higher and 800° C. or lower into a casting mold. Alternatively, an ingot can also be obtained by semi-continuous casting which is generally used.

The obtained ingot of the aluminum alloy 1 can be directly cut and used as the material of the anode active material. The ingot may be processed into a plate material by rolling, extrusion, forging, or the like.

### [Step of Preparing Material of Anode of Aluminum Alloy 1]

In a case where the aluminum alloy 1 is used as the material of the anode active material, the element M1 is added to molten aluminum and melted at 680° C. or higher and 800° C. or lower to obtain a molten alloy of aluminum and the element M1. The subsequent process is performed by the same method as in [Step of Preparing Material of Anode Active Material Layer] to obtain the aluminum alloy 1 as the material of the anode.

The element M1 may be added alone, or a plurality of elements may be added.

### [Step of Preparing Material of Current Collector Layer]

In a case where the aluminum alloy 2 is used as a material of the current collector layer, the element M2 is added to molten aluminum and melted at 680° C. or higher and 800° C. or lower to obtain a molten alloy of Al and the element M2. The subsequent process is performed by the same method as in [Step of Preparing Material of Anode Active Material Layer] to obtain the material of the current collector layer.

As the material of the current collector layer, a commercially available aluminum alloy 2 may be used. Examples of a commercially available product of the aluminum alloy 2 include A3003 (aluminum-manganese alloy) and A5052 (aluminum-magnesium alloy).

### [Roughening Step]

Each of bonding surfaces of the material of the anode active material layer and the material of the current collector layer thus obtained are roughened. Roughening enables stronger bonding between the anode active material layer and the current collector layer.

In the roughening step, for example, the bonding surfaces may be polished with polishing means. By the polishing, surface roughnesses (Ra) of the bonding surfaces of the material of the anode active material layer and the material of the current collector layer are both set to preferably 0.7 μm or more, more preferably 0.8 μm or more, and still more preferably 1.0 μm or more.

In order to roughen the bonding surfaces of the material of the anode active material layer and the material of the current collector layer, known polishing means such as a brush or abrasive paper may be used.

### [Cladding Step]

It is preferable to perform a surface treatment on the bonding surfaces of the material of the anode active material layer and the material of the current collector layer before cladding. As the surface treatment, alcohol degreasing and surface polishing are preferable.

The anode 100 is obtained by overlapping the bonding surfaces of the material of the anode active material layer and the material of the current collector layer and cladding the overlapped materials by roll bonding.

### <Manufacturing Method 2 of Anode for Lithium Secondary Battery>

A method of manufacturing the anode of the second embodiment will be described.

The anode can be manufactured by the same method as in <Manufacturing Method 1 of Anode for Lithium Secondary Battery> except that a laminate in which a pair of materials of the anode active material are directly laminated on both surfaces of the material of the current collector layer is obtained.

The materials of the anode active material layer may be the same as or different from each other. From the viewpoint of easily manufacturing, it is preferable that the materials of the anode active material have the same constituent metal element.

For example, in a case where aluminum X is used as the anode active material layer 11a, the anode active material layer 11b may use aluminum X, or may use aluminum Y, which has a different purity of Al from that of aluminum X. The purities of the aluminum X and the aluminum Y may be adjusted as appropriate in the step of highly purifying the aluminum by the above-described segregation method or the three-layer electrolysis method.

In addition, for example, in a case where an aluminum alloy X is used as the anode active material layer 11a, the anode active material layer 11b uses an aluminum alloy Y having the same constituent metal element as that of the aluminum alloy X. The aluminum alloy X and the aluminum alloy Y may have the same or different content ratios of the element M1. In this case, the amount of the element M1 to be added to the molten aluminum may be adjusted as appropriate.

### <Lithium Secondary Battery>

Next, a secondary battery having the anode of the present embodiment will be described. As an example, a lithium secondary battery using a lithium cathode active material for the cathode will be described.

An example of the lithium secondary battery has a cathode, an anode, a separator interposed between the cathode and the anode, and an electrolytic solution disposed between the cathode and the anode.

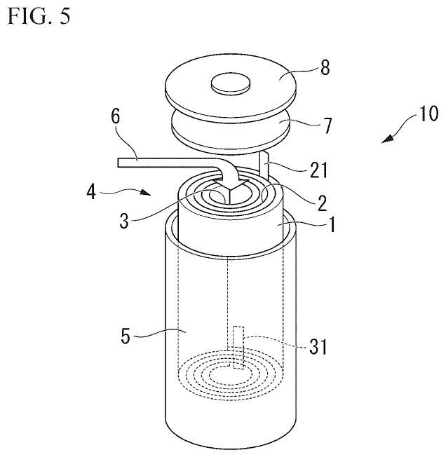

FIG. 5 is a schematic view showing an example of the lithium secondary battery. A cylindrical lithium secondary battery 10 is manufactured as follows.

First, as shown in FIG. 5, a pair of separators 1 having a strip shape, a strip-shaped cathode 2 having a cathode lead 21 at one end, and a strip-shaped anode 3 having a anode lead 31 at one end are stacked in order of the separator 1, the cathode 2, the separator 1, and the anode 3 and are wound to form an electrode group 4.

Next, the electrode group 4 and an insulator (not shown) are accommodated in a battery can 5, a can bottom is then sealed, the electrode group 4 is impregnated with an electrolytic solution 6, and an electrolyte is disposed between the cathode 2 and the anode 3. Furthermore, an upper portion of the battery can 5 is sealed with a top insulator 7 and a sealing body 8, whereby the lithium secondary battery 10 can be manufactured.

Examples of a shape of the electrode group 4 include a columnar shape in which a cross-sectional shape when the electrode group 4 is cut in a direction perpendicular to a winding axis becomes a circle, an ellipse, a rectangle, or a rectangle with rounded corners.

In addition, as a shape of the lithium secondary battery having the electrode group 4, a shape defined by IEC60086, which is a standard for a battery defined by the International Electrotechnical Commission (IEC), or by JIS C 8500 can be adopted. Examples thereof include shapes such as a cylindrical shape or a square shape.

Furthermore, the lithium secondary battery is not limited to the wound type configuration, and may have a stacked type configuration in which a stacked structure of a cathode, a separator, an anode, and a separator is repeatedly stacked. A so-called coin type battery, a button type battery, and a paper type (or sheet type) battery are exemplary examples of the stacked type lithium secondary battery.

Hereinafter, each configuration will be described in order.

### (Cathode)

The cathode can be manufactured by first adjusting a cathode mixture containing a cathode active material, a conductive material, and a binder, and supporting the cathode mixture by a cathode current collector.

### (Cathode Active Material)

As the cathode active material, a material containing a lithium-containing compound or a compound containing another metal can be used. Examples of the lithium-containing compound include a lithium cobalt complex oxide having a layered structure, a lithium nickel complex oxide having a layered structure, a lithium manganese complex oxide having a spinel structure, and a lithium iron phosphate having an olivine structure. Examples of the compound containing another metal include oxides such as titanium oxide, vanadium oxide, and manganese dioxide, and sulfides such as titanium sulfide and molybdenum sulfide.

### (Conductive Material)

As the conductive material included in the cathode, a carbon material can be used. Examples of the carbon material include graphite powder, carbon black (for example, acetylene black), and a fibrous carbon material.

A proportion of the conductive material in the cathode mixture is preferably 5 to 20 parts by mass with respect to 100 parts by mass of the cathode active material.

### (Binder)

As the binder in the cathode, a thermoplastic resin can be used. As the thermoplastic resin, polyimide resins; fluororesins such as polyvinylidene fluoride (hereinafter, sometimes referred to as PVdF) and polytetrafluoroethylene; polyolefin resins such as polyethylene and polypropylene, and the resins described in WO 2019/098384A1 or US2020/0274158A1 can be exemplary examples.

### (Cathode Current Collector)

As the cathode current collector included in the cathode, a strip-shaped member formed of a metal material such as Al, Ni, or stainless steel as a forming material can be used.

As a method for supporting the cathode mixture by the cathode current collector, a method in which a paste of the cathode mixture is prepared using an organic solvent, the obtained paste of the cathode mixture is applied to at least one surface side of the cathode current collector and dried, and the paste is fixed by performing an electrode pressing step is an exemplary example.

As the organic solvent that can be used in a case where the paste of the cathode mixture is prepared. N-methyl-2-pyrrolidone (hereinafter, referred to as NMP in some cases) is an exemplary example.

Examples of a method of applying the paste of the cathode mixture to the cathode current collector include a slit die coating method, a screen coating method, a curtain coating method, a knife coating method, a gravure coating method, and an electrostatic spraying method.

The cathode can be manufactured by the method mentioned above.

### (Anode)

As the anode included in the lithium secondary battery of the present embodiment, the anode of the present embodiment described above is used.

### (Anode Current Collector)

The anode of the present embodiment is a current collector-integrated anode. The current collector-integrated anode may be used alone, or may be used in combination with a current collector.

### (Separator)

As the separator included in the lithium secondary battery, for example, a material that is made of a material such as a polyolefin resin such as polyethylene or polypropylene, a fluororesin, or a nitrogen-containing aromatic polymer and has a form such as a porous film, a non-woven fabric, or a woven fabric can be used. In addition, two or more of these materials may be used to form the separator, or these materials may be laminated to form the separator.

In the present embodiment, an air resistance of the separator according to the Gurley method defined by JIS P 8117 is preferably 50 sec/100 cc or more and 300 sec/100 cc or less, and more preferably 50 sec/100 cc or more and 200 sec/100 cc or less in order for the electrolyte to have good permeation during battery use (during charging and discharging).

In addition, a porosity of the separator is preferably 30 vol % or more and 80 vol % or less and more preferably 40 vol % or more and 70 vol % or less with respect to a total volume of the separator. The separator may be a laminate of separators having different porosities.

### (Electrolytic Solution)

The electrolytic solution included in the lithium secondary battery contains an electrolyte and an organic solvent.

Examples of the electrolyte contained in the electrolytic solution include lithium salts such as LiClO₄, LiPF₆, LiAsF₆, LiSbF₆, LiBF₄, LiCFSO₃, LiN(SO₂CF₃)₂, LiN(SO₂C₂F₅)₂, LiN(SO₂CF₃)(COCF₃), Li(C₄F₉SO₃), LiC(SO₂CF₃)₃, Li₂B₁₀Cl₁₀, LiBOB (here, BOB refers to bis(oxalato)borate), LiFSI (here, FSI refers to bis(fluorosulfonyl)imide), lower aliphatic carboxylic acid lithium salts, and LiAlCl₄, and a mixture of two or more of these may be used. Among these, as the electrolyte, it is preferable to use at least one selected from the group consisting of LiPF₆. LiAsF₆, LiSbF₆, LiBF₄, LiCF₃SO₃, LiN(SO₂CF₃)₂, and LiC(SO₂CF₃)₃, which contain fluorine.

In addition, as the organic solvent that is contained in the electrolytic solution, for example, carbonates such as propylene carbonate, ethylene carbonate, dimethyl carbonate, diethyl carbonate, ethyl methyl carbonate, 4-trifluoromethyl-1,3-dioxolan-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, propyl propionate, and γ-butyrolactone; nitriles such as acetonitrile and butyronitrile; amides such as N,N-dimethylformamide and N,N-dimethylacetamide; carbamates such as 3-methyl-2-oxazolidone; and sulfur-containing compounds such as sulfolane, dimethyl sulfoxide, and 1,3-propanesultone, or those obtained by further introducing a fluoro group into these organic solvents (those obtained by substituting one or more hydrogen atoms in the organic solvents with a fluorine atom) can be used.

As the organic solvent, it is preferable to use a mixture of two or more thereof. Among these, a mixed solvent containing a carbonate is preferable, and a mixed solvent of a cyclic carbonate and a non-cyclic carbonate and a mixed solvent of a cyclic carbonate and an ether are more preferable. As the mixed solvent of a cyclic carbonate and a non-cyclic carbonate, a mixed solvent containing ethylene carbonate, dimethyl carbonate, and ethyl methyl carbonate is preferable. An electrolytic solution using such a mixed solvent has a wide operating temperature range, does not easily deteriorate even when charging and discharging are performed at a high current rate, and does not easily deteriorate even during a long-term use.

Furthermore, as the electrolytic solution, it is preferable to use an electrolytic solution containing a lithium salt containing fluorine such as LiPF₆ and an organic solvent having a fluorine substituent in order to enhance the safety of the obtained lithium secondary battery. A mixed solvent containing an ether having a fluorine substituent such as pentafluoropropyl methyl ether or 2,2,3,3-tetrafluoropropyl difluoromethyl ether and dimethyl carbonate is even more preferable because a capacity retention ratio is high even when charging and discharging are performed at a high current rate.

The electrolytic solution may contain additives such as tris(trimethylsilyl) phosphate and tris(trimethylsilyl) borate.

A solid electrolyte may be used instead of the electrolytic solution. As the solid electrolyte, for example, an organic polymer electrolyte such as a polyethylene oxide-based polymer compound, or a polymer compound containing at least one or more of a polyorganosiloxane chain or a polyoxyalkylene chain can be used. A so-called gel type in which a non-aqueous electrolytic solution is held in a polymer compound can also be used. In addition, inorganic solid electrolytes containing sulfides such as Li₂S—SiS₂. Li₂S—GeS₂, Li₂S—P₂S₅, Li₂S—B₂S₃, Li₂S—SiS₂—Li₃PO₄, Li₂S—SiS₂—Li₂SO₄, and Li₂S—GeS₂—P₂S₅ can be adopted, and a mixture of two or more thereof may be used. By using these solid electrolytes, the safety of the lithium secondary battery can be further enhanced.

In addition, in a case of using the solid electrolyte in the lithium secondary battery of the present embodiment, there may be cases where the solid electrolyte serves as the separator, and in such a case, the separator may not be required.

The present invention includes the following [11] to [16].

[11] An anode for a lithium secondary battery, including: a cladding material obtained by bonding an anode active material layer and a current collector layer to each other, in which the anode active material layer contains aluminum, the current collector layer is made of a metal foil, and the anode active material layer satisfies (1) and (2) in which
(1): an average voltage of a lithium alloying reaction in the anode active material layer measured using lithium metal as a counter electrode of the anode active material layer is 0.05 V or more and 0.5 V or less, and
(2): the average voltage of the lithium alloying reaction in the anode active material layer measured using lithium metal as the counter electrode of the anode active material layer is higher than an average voltage of a lithium alloying reaction in the current collector layer, and a difference in the average voltage of the lithium alloying reaction between the anode active material layer and the current collector layer is 0.05 V or more and 0.3 V or less.

[12] The anode for a lithium secondary battery according to [11], in which the current collector layer is an aluminum alloy having a lower content ratio of Al than the anode active material layer.

[13] The anode for a lithium secondary battery according to [11] or [12], in which the current collector layer contains an element M2 which is one or more elements selected from the group consisting of Si, Fe, Ni, Cu, Mn, and Mg, and a content ratio of the element M2 to a total amount of the current collector layer is 1 mass % or more and 5 mass % or less.

[14] The anode for a lithium secondary battery according to any one of [11] to [13], in which the anode active material layer contains aluminum, and a content ratio of an inevitable impurity contained in the aluminum is less than 0.1 mass %. [15] The anode for a lithium secondary battery according to any one of [11] to [14], in which the anode active material layer contains an element M1 which is one or more elements selected from the group consisting of Si, Ge, Sn, Ag, Sb, Bi, In, Mn, and Mg, and a content ratio of the element M1 to a total amount of the anode active material layer is 0.5 mass % or more and 7.8 mass % or less.

[16] A lithium secondary battery including: the anode for a lithium secondary battery according to any one of [11] to [15].

### EXAMPLES

Next, the present invention will be described in more detail with reference to examples.

### Example 1

### [Production of Anode]

### Preparation of Material of Anode Active Material Layer

As the material of the anode active material layer, aluminum having a purity of Al of 99.99 mass % or more was used. A thickness of the aluminum was set to 300 μm.

### Preparation of Material of Current Collector Layer

As the material of the current collector layer, an aluminum-silicon alloy 2, which was an alloy of aluminum having a purity of Al of 99.99 mass % or more and silicon, was manufactured.

First, aluminum having a purity of 99.99 mass % or more and silicon manufactured by Tokuyama Corporation and having a purity of Si of 99.999 mass % or more were heated and held at 760° C. to be melted, thereby obtaining a molten aluminum-silicon alloy.

Next, the molten aluminum-silicon alloy was held at 700° C. for 2 hours under a condition of a degree of vacuum of 50 Pa to be cleaned. The molten aluminum-silicon alloy was stirred for 1 minute, and then cast in a cast iron casting mold (22 mm/150 mm×200 mm) dried at 150° C., thereby obtaining an aluminum-silicon ingot. At this time, a ratio of Si to a total mass of the aluminum-silicon ingot was 1 mass %. The aluminum-silicon ingot was subjected to rolling processing to obtain a rolled material having a thickness of 300 μm.

### Surface Treatment

Bonding surfaces of the aluminum as the material of the anode active material layer and the aluminum-silicon rolled material as the material of the current collector layer were each degreased, and polished in one direction using abrasive paper (No. 100).

The bonding surfaces of the material of the anode active material layer and the aluminum-silicon rolled material were overlapped with each other, and subjected to a plurality of cold rolling processes from a thickness of 600 μm at a processing rate of 50%, thereby obtaining a rolled material having a thickness of 66 μm. The rolled material was cut into a disk shape having a diameter of Φ15 mm, thereby manufacturing an anode (cladding material) including the anode active material layer of 30 μm and the current collector layer of 33 μm.

### [Manufacturing of Lithium Secondary Battery]

A lithium secondary battery was manufactured by the method described above in (Manufacturing of Lithium Secondary Battery: for measurement of V1 and V2).

### [Measurement of V1 and V2]

A lithium secondary battery was manufactured by the method described above in (Manufacturing of Lithium Secondary Battery 1). Furthermore, V1 and V2 were measured by the method described above in [Method for Measuring Average Voltage of Lithium Alloying Reaction].

A difference (V1−V2) between V1 and V2 was calculated from the obtained value.

As a result, in the anode of Example 1, V1 was 0.30 V, V2 was 0.21 V, and V1−V2 was 0.09 V.

### [Measurement of Cycle Retention Ratio]

A lithium secondary battery 2 was manufactured by the method described above in [Method of Measuring Cycle Retention Ratio], and a cycle retention ratio was measured. As a result, the cycle retention ratio based on the determination criteria 1 was 80%.

### Example 2

V1 and V2 were measured in the same manner as in Example 1, except that the anode active material layer was changed to the aluminum-silicon alloy 2 and the current collector layer was changed to A3003 (aluminum-manganese alloy).

As a result, in the anode of Example 2, V1 was 0.30 V, V2 was 0.20 V, and V1−V2 was 0.10 V. A cycle retention ratio based on the determination criteria 2 was 97%.

### Example 3

V1 and V2 were measured in the same manner as in Example 1, except that the anode active material layer was changed to the aluminum-silicon alloy 2 and the current collector layer was changed to A5052 (aluminum-magnesium alloy).

As a result, in the anode of Comparative Example 1, V1 was 0.30 V, V2 was 0.12 V, and V1−V2 was 0.18 V. A cycle retention ratio based on the determination criteria 2 was 90%.

### Comparative Example 1

V1 and V2 were measured in the same manner as in Example 1, except that the current collector layer was changed to aluminum having a purity of Al of 99.99 mass % or more.

As a result, in the anode of Comparative Example 1, V1 was 0.30 V, V2 was 0.30 V, and V1−V2 was 0 V. A cycle retention ratio based on the determination criteria 1 was 50%.

In Examples 1, 2, and 3, the cycle retention ratios were as high as 80% or more. This is considered to be because, in a case where charging and discharging were repeated, while the anode active material layer had reacted, the current collector layer had a portion remained unchanged in composition and could maintain a function as the current collector.

It is considered that the reason why the cycle retention ratio of Comparative Example 1 was as low as 50% was that a portion for maintaining a function of the current collector was eroded by charging and discharging, and thus the function of the current collector could not be maintained.

### REFERENCE SIGNS LIST

1: Separator
3: Anode
4: Electrode group
5: Battery can
6: Electrolytic solution
7: Top insulator
8: Sealing body
10: Lithium secondary battery
21: Cathode lead
100, 101: Anode for a lithium secondary battery
11, 11a, 11b: Anode active material layer
12: Current collector layer

1. An anode for a lithium secondary battery, comprising:
a cladding material obtained by bonding an anode active material layer and a current collector layer to each other,
wherein the anode active material layer contains aluminum,
the current collector layer is made of a metal foil, and
the anode active material layer satisfies (1) and (2) in which
(1): an average voltage of a lithium alloying reaction in the anode active material layer measured using lithium metal as a counter electrode of the anode active material layer is 0.05 V or more, and
(2): the average voltage of the lithium alloying reaction in the anode active material layer measured using lithium metal as the counter electrode of the anode active material layer is higher than an average voltage of a lithium alloying reaction in the current collector layer, and a difference in the average voltage of the lithium alloying reaction between the anode active material layer and the current collector layer is 0.05 V or more and 0.5 V or less.

2. The anode for a lithium secondary battery according to claim 1,
wherein the current collector layer is an aluminum alloy having a lower content ratio of Al than the anode active material layer.

3. The anode for a lithium secondary battery according to claim 1,
wherein the current collector layer contains an element M2 which is one or more elements selected from the group consisting of Si, Fe, Ni, Cu, Mn, and Mg, and
a content ratio of the element M2 to a total amount of the current collector layer is 0.1 mass % or more.

4. The anode for a lithium secondary battery according to claim 1,
wherein the anode active material layer contains aluminum, and
a content ratio of an inevitable impurity contained in the aluminum is less than 0.1 mass %.

5. The anode for a lithium secondary battery according to claim 1,
wherein the anode active material layer contains an element M1 which is one or more elements selected from the group consisting of Si, Ge, Sn, Ag, Sb, Bi, In, Mn, and Mg, and
a content ratio of the element M1 to a total amount of the anode active material layer is 0.1 mass % or more and 8 mass % or less.

6. A lithium secondary battery comprising:
the anode for a lithium secondary battery according to claim 1.

7. The anode for a lithium secondary battery according to claim 2,
wherein the current collector layer contains an element M2 which is one or more elements selected from the group consisting of Si, Fe, Ni, Cu, Mn, and Mg, and
a content ratio of the element M2 to a total amount of the current collector layer is 0.1 mass % or more.

8. The anode for a lithium secondary battery according to claim 2,
wherein the anode active material layer contains aluminum, and
a content ratio of an inevitable impurity contained in the aluminum is less than 0.1 mass %.

9. The anode for a lithium secondary battery according to claim 2,
wherein the anode active material layer contains an element M1 which is one or more elements selected from the group consisting of Si, Ge, Sn, Ag, Sb, Bi, In, Mn, and Mg, and
a content ratio of the element M1 to a total amount of the anode active material layer is 0.1 mass % or more and 8 mass % or less.

10. A lithium secondary battery comprising:
the anode for a lithium secondary battery according to claim 2.
